(19) United States
(12) Patent Application Publication
(10) Pub. No.: US 2003/0158504 A1
(43) Pub. Date: Aug. 21, 2003

(54) Massaging apparatus

(76) Inventors: Kazuya Hiyamizu, Osaka (JP); Masahiko Hashimoto, Osaka (JP); Hirokazu Genno, Osaka (JP)

Correspondence Address: ARMSTRONG,WESTERMAN & HATTORI, LLP, 1725 K STREET, NW, SUITE 1000, WASHINGTON, DC, 20006, US

(21) Appl. No.: 10/353,059

(22) Filed: Jan. 29, 2003

(30) Foreign Application Priority Data
Jan. 31, 2002 (JP) 2002-024827

(51) Int. Cl. A61H 15/00

(52) U.S. Cl. 601/99; 601/100; 601/102; 601/103; 601/116

(57) ABSTRACT

A massaging apparatus includes: a potentiometer for detecting a change in the swing angle of a swinging arm in the process of reciprocating massaging members; a skewness detector 60 for measuring skewness of the user being in contact with the massaging members, based on the change in the swing angle detected by the potentiometer; and a massaging operation controller 63 for controlling a massaging operation according to the degree and pattern of skewness detected by the skewness detector 60. With this massaging apparatus, it is possible to correct the skewness or the like and reduce stiffness by giving a suitable massage to each user, according to the skewness of the body, unbalance between the left and right sides, and differences in physical attributes.

### BACKGROUND OF THE INVENTION

1. Field of the Invention

The present invention relates to a massaging apparatus mounted in a chair, and more particularly relates to a massaging apparatus capable of realizing a massaging operation suitable for the human body form of a user (person receiving a massage).

2. Description of Related Art

FIG. 1 is a perspective view showing a conventional massaging apparatus.

This massaging apparatus is constructed by installing a massaging mechanism 2 comprising a plurality of massaging members 21 in a chair 10 composed of a leg portion 11, a seat portion 12, a backrest portion 13 and a pair of left and right armrest portions 14. The massaging apparatus is designed to give a massage to the human body by reciprocating these massaging members 21 in upward and downward directions while vibrating them.

FIG. 2 is a rear view showing the massaging mechanism 2.

The massaging mechanism 2 includes a massaging member driving device 3 for vibrating the massaging members 21, in the rear part of the backrest portion 13 of the chair 10. The massaging member driving device 3 is supported so that it can move upward and downward along side frames 15 which are mounted on the rear face of the backrest portion 13.

A massaging member movement driving mechanism 25 comprises a massaging member movement driving motor 22. The massaging member movement driving motor 22 is connected to a screw shaft 23 through a band transmission mechanism 20.

The screw shaft 23 is screwed into a bearing 24 attached to the massaging member driving device 3. When the massaging member movement driving motor 22 drives the screw shaft 23 to rotate, the massaging member driving device 3 moves upward and downward.

FIG. 3 is a rear view showing the massaging member driving device 3.

The massaging member driving device 3 includes a plurality of rollers 43 on both sides. These rollers 43 are fitted in the side frames 15 to allow the up-down movement of the massaging member driving device 3.

The massaging member driving device 3 comprises a kneading operation driving motor 31. The kneading operation driving motor 31 is connected to an output shaft 34 through a band transmission mechanism 32 and a gearshift mechanism 33. A pair of left and right eccentric bearings 35 is attached to the output shaft 34. These eccentric bearings 35 support a pair of left and right support arms 42.

A substantially L-shaped swinging arm 36 is fitted to the top end of each support arm 42, and the massaging members 21 are attached rotatably to both ends of each swinging arm 36.

In this structure, when the kneading operation driving motor 31 driven the output shaft 34 to rotate, the support arms 42 are driven to swing in open and close directions, thereby realizing a kneading operation by the massaging members 21.

Note that the width between the pair of left and right massaging members 21 is adjustable by controlling the rotation of the kneading operation driving motor 31.

The massaging member driving device 3 further comprises a tapping operation driving motor 37. The tapping operation driving motor 37 is connected to an output shaft 39 through a band transmission mechanism 38. A pair of left and right eccentric bearings 40 is attached to the output shaft 39. These eccentric bearings 40 support a pair of left and right rods 41. The top end of each rod 41 is connected to the base part of each support arm 42. In this structure, when the tapping operation driving motor 37 drives the output shaft 39 to rotate, the rods 41 are driven to swing in forward and backward directions, thereby realizing a tapping operation by the massaging members 21.

The above-described conventional massaging apparatus gives a massage to the human body by performing the above-mentioned kneading operation and tapping operation while reciprocating the massaging members 21 in upward and downward directions along a predetermined track. However, since the users (persons receiving massages) have different physical attributes and, for example, the positions of bones such as scapulae vary depending on individuals, some person may feel pain when the massaging members 21 come into contact with his/her bones in the process of moving the massaging members 21 along the predetermined track.

Therefore, the present inventor et al. developed a massaging apparatus capable of reducing the pain caused by differences in physical attributes as disclosed in Japanese Patent Application Laid-Open No. 2001-269378.

This massaging apparatus comprises a potentiometer on the axis of the swinging arm 36, detects a change in the swing angle of the swinging arm 36 with this potentiometer, and controls the operations of the massaging mechanism 2 and the massaging member movement driving mechanism 25, based on the detection signal.

In the process of moving the massaging members 21 from the head to the back of the human body, the swinging arm 36 swings according to the curves of the human body following the track of the massaging members 21, and a change in the swing angle (arm angle) in this moment is detected by the potentiometer. On a flat part of the human body, the arm angle is maintained constant. Whereas on the positions of the back part of the head, the joint of the head, shoulders and scapulae, the arm angle changes abruptly and an inflection point is caused at each position. Here, by performing second-order differentiation for a change in the arm angle, a positive or a negative peak is obtained for each position. Based on the result of detecting this peak position and the results of detecting the positions of the massaging members 21, the positions of the back part of the head, the joint of the head, the shoulders and scapulae of the user are detected. Then, the human body form is estimated from these positions, and the human body form data of the user is created.

In this massaging apparatus, the human body form data and data indicating points that the user feels comfortable or uncomfortable when receiving a massage are created, and then an operation table for an actual massaging operation is updated based on these data. When using the massaging apparatus, a massaging operation is executed while avoiding the uncomfortable points, or reducing the operation speed at the uncomfortable points, based on the operation table.

With this massaging apparatus, by updating the operation table in accordance with the physical attribute of the user, it is possible to avoid pain from being caused by the contact of the massaging members 21 with his/her bones. However, the conventional massaging apparatus does not utilize the created human body form data of the user for the elimination of stiffness.

Stiffness is caused by the skewness and unbalance between the left and right sides of the human body form, and stiffness sometimes causes a skew in the body. Accordingly, the present inventor et al. found that it is possible to realize a suitable massage for each user by detecting skewness of the body of the user, based on the change in the swing angle of the swinging arm 36 when performing a massaging operation on the user, and controlling the massaging operation, based on the detected skewness.

### BRIEF SUMMARY OF THE INVENTION

The present invention has been made with the aim of solving the above problems, and it is an object thereof to provide a massaging apparatus capable of giving a massage, particularly on the muscles receiving high stress due to skewness of the body, and providing a massage suitable for the physical attribute of each user, and thereby correcting the skewness and reducing stiffness.

It is another object of the present invention to provide a massaging apparatus capable of detecting skewness of the body of a user easily and accurately and providing a massage more suitable for the physical attribute of each user, and thereby correcting the skewness and reducing stiffness.

Still another object of the present invention is to provide a massaging apparatus capable of detecting the degree and pattern of skewness of the body of a user accurately and providing a massage more suitable for the physical attribute of each user, and thereby correcting the skewness and reducing stiffness.

Yet another object of the present invention is to provide a massaging apparatus capable of detecting the degree and pattern of unbalance between the left and right sides of the body of a user accurately and providing a massage suitable for the physical attribute of each user, and thereby correcting the unbalance between the left and right sides and reducing stiffness.

It is a further object of the present invention to provide a massaging apparatus capable of detecting the physical attribute in a cross direction of each user and providing a massage more suitable for the physical attribute of each user, and thereby reducing stiffness.

Another object of the present invention is to provide a massaging apparatus capable of detecting the physical attributes in a cross direction and a longitudinal direction of each user accurately and providing a massage more suitable for the physical attribute of each user, and thereby reducing stiffness.

Still another object of the present invention is to provide a massaging apparatus capable of transmitting the outputted data about a user, such as data relating to the skewness and unbalance, to medical professionals and thereby enabling diagnosis for skewness and unbalance of the body of the user and the degree of abnormality in the body due to the skewness and unbalance, and utilization of such data for health management and massages.

A massaging apparatus of the present invention causes a massaging member attached to an end of a swinging arm to perform a predetermined massaging operation. The massaging apparatus detects skewness of the body of a user, based on a change in the swing angle of the swinging arm when performing the massaging operation on the user, and controls the massaging operation, based on the detected skewness.

Based on the detected skewness, this massaging apparatus gives a massage, particularly on the muscles receiving high stress due to skewness, and performs a massage suitable for the physical attribute of each user to correct the skewness of the body and reduce stiffness of the body.

A massaging apparatus of the present invention comprises a pair of support arms; a swinging arm supported on each top end of the support arms so that the swinging arm can freely swing; a pair of massaging members mounted on both ends of each swinging arm; kneading operation driving means for performing a kneading operation by opening and closing the two support arms in left and right directions; reciprocation driving means for reciprocating the support arms in a longitudinal direction; and tapping operation driving means for performing a tapping operation by swinging the support arms in forward and backward directions. The massaging apparatus may further comprise: swing angle detecting means for detecting a change in a swing angle of each swinging arm in the process of reciprocating the support arms; form detecting means for detecting a body form of a user, based on the change in the swing angle detected by the swing angle detecting means; skewness detecting means for detecting skewness of the body of the user, based on the body form of the user detected by the form detecting means; and drive-control means for controlling driving of the kneading operation driving means, reciprocation driving means and tapping operation driving means, based on the skewness detected by the skewness detecting means.

With this massaging apparatus, it is possible to detect the skewness of the body of the user easily and accurately, and perform a massage more suitable for the physical attribute of each user to correct the skewness of the body and reduce stiffness.

The massaging apparatus of the present invention may further comprise: reference angle change curve storing means for storing a reference angle change curve that indicates a change in the swing angle based on a reference physical attribute; position detecting means for detecting positions of respective parts of the body of the user, based on the change in the swing angle detected by the swing angle detecting means; corrected angle change curve creating means for creating a corrected angle change curve by correcting the reference angle change curve stored in the reference angle change curve storing means, based on the positions detected by the position detecting means; and measured angle change curve creating means for creating a measured angle change curve of the user, based on the change in the swing angle detected by the swing angle detecting means. The skewness detecting means detects skewness by comparing the corrected angle change curve created by the corrected angle change curve creating means with the measured angle change curve created by the measured angle change curve creating means. The drive-control means controls driving of the kneading operation driving means, reciprocation driving means and tapping operation driving means, based on the skewness detected by the skewness detecting means.

With this massaging apparatus, it is possible to detect the degree and pattern of skewness of the body of the user accurately, and perform a massage more suitable for the physical attribute of each user to correct the skewness of the body and reduce stiffness.

Besides, the massaging apparatus of the present invention may further comprise: left and right measured angle change curve creating means for creating measured angle change curves of the user, based on changes in the swing angles of the left and right swinging arms, respectively; and left and right skewness detecting means for detecting left and right skewness of the user by comparing the left and right measured angle change curves created by the left and right measured angle change curve creating means with each other. The drive-control means controls driving of the kneading operation driving means, reciprocation driving means and tapping operation driving means, based on the skewness detected by the left and right skewness detecting means.

With this massaging apparatus, it is possible to detect the degree and pattern of unbalance between the left and right sides of the body of the user accurately, and perform a massage suitable for the physical attribute of each user to correct the unbalance between the left and right sides and reduce stiffness.

In addition, the massaging apparatus of the present invention may further comprise: swing angle detecting means for detecting a change in the swing angle of the swinging arm in the process of performing the kneading operation by opening and closing the support arms in left and right directions; and cross-directional form detecting means for detecting a body form in a cross direction of the user, based on the change in the swing angle detected by the swing angle detecting means. The drive-control means controls driving of the kneading operation driving means, reciprocation driving means and tapping operation driving means, based on the body form in a cross direction of the user detected by the cross-directional form detecting means.

With this massaging apparatus, it is possible to detect the physical attribute in the cross direction of each user, and perform a massage more suitable for the physical attribute of each user to reduce stiffness.

The massaging apparatus of the present invention may further comprise: storing means for storing a curvatures—physical attributes table that indicates a relationship between the curvatures of the back and lower back part and physical attributes, and a physical attributes—massaging operations table that indicates a relationship between physical attributes and massaging operations; longitudinal curvature estimating means for estimating longitudinal curvatures of the back and lower back part, based on an inclination of the change in the swing angle detected by the swing angle detecting means in the process of reciprocating the support arms, for each of the positions of the back and lower back part of the user detected by the position detecting means; cross-directional curvature estimating means for estimating cross-directional curvatures of the back and lower back part, based on an inclination of the change in the swing angle detected by the swing angle detecting means in the process of performing the kneading operation by opening and closing the support arms in left and right directions, for each of the positions; physical attribute detecting means for detecting a physical attribute of the user from the curvatures—physical attributes table stored in the storing means, based on the longitudinal curvatures and cross-directional curvatures estimated by the longitudinal curvature estimating means and cross-directional curvature estimating means; and massaging operation deciding means for deciding a massaging operation from the physical attributes—massaging operations table stored in the storing means, based on the physical attribute of the user detected by the physical attribute detecting means. The drive-control means controls driving of the kneading operation driving means, reciprocation driving means and tapping operation driving means, based on the massaging operation decided by the massaging operation deciding means.

With this massaging apparatus, it is possible to detect the physical attributes in a longitudinal direction and a cross direction of each user accurately, and perform a massage more suitable for the physical attribute of each user to reduce stiffness.

The massaging apparatus of the present invention may further comprise means for outputting the skewness detected by the skewness detecting means to an external device.

With this massaging apparatus, by transmitting the outputted data about the user, such as data relating to skewness and unbalance, to medical professionals, it is possible to have a diagnosis for skewness and unbalance of the body of the user and the degree of abnormality in the body due to the skewness and unbalance, and utilize such data for health management and massaging methods.

The above and further objects and features of the invention will more fully be apparent from the following detailed description with accompanying drawings.

### BRIEF DESCRIPTION OF THE SEVERAL VIEWS OF THE DRAWINGS

FIG. 1 is a perspective view showing the state of a massaging apparatus in use;

FIG. 2 is a rear view showing the structure of a massaging mechanism;

FIG. 3 is a rear view showing the structure of a massaging member driving device;

FIG. 4 is a side view showing a potentiometer provided on a swinging arm;

FIG. 5 is a block diagram showing the structure of a control system of a massaging apparatus according to the first embodiment of the present invention;

FIG. 6 is a view for explaining a change in the swing angle of the swinging arm due to the movement of massaging members;

FIG. 7 is a flow chart showing the process of detecting skewness of the user and controlling the massaging operation in a control circuit;

FIG. 8 is a graph showing the relationship between the swing angle of the swinging arm and the height of the massaging members, and is also a view for explaining the correction of a reference angle change curve;

FIG. 9 is a graph showing the relationship between the swing angle of the swinging arm and the height of the massaging members, and is also a view for explaining the detection of the degree and pattern of skewness;

FIG. 10 is a flow chart showing the process of detecting an unbalance between the left and right sides of the body of the user and controlling the massaging operation in the control circuit;

FIG. 11 is a graph showing the relationship between the swing angle of the swinging arm and the height of the massaging members, and is also a view for explaining the detection of the degree and pattern of unbalance between the left and right sides;

FIG. 12 is a block diagram showing the structure of a control system of a massaging apparatus according to the second embodiment of the present invention;

FIG. 13 is a flow chart showing the process of detecting the physical attribute of the user and controlling the massaging operation in a control circuit; and

FIG. 14 is a graph showing the relationship between the swing angle of the swinging arm and the width between the massaging members when a kneading operation is performed on the back of the user.

### DETAILED DESCRIPTION OF THE INVENTION

The following description will explain the present invention in detail based on the drawings illustrating some embodiments thereof.

First Embodiment

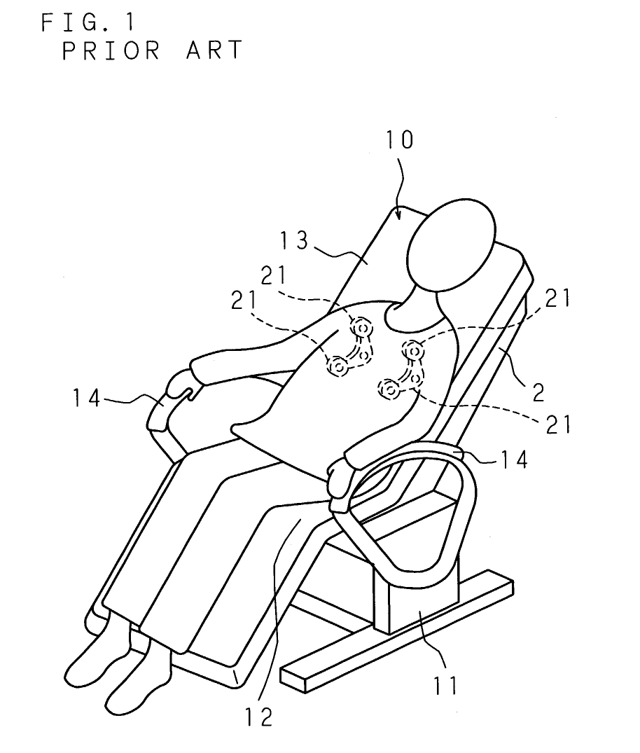

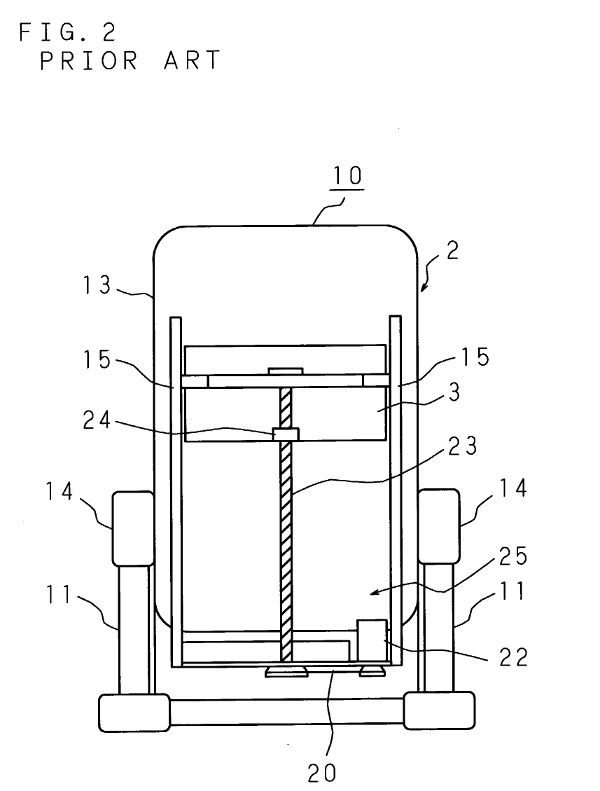

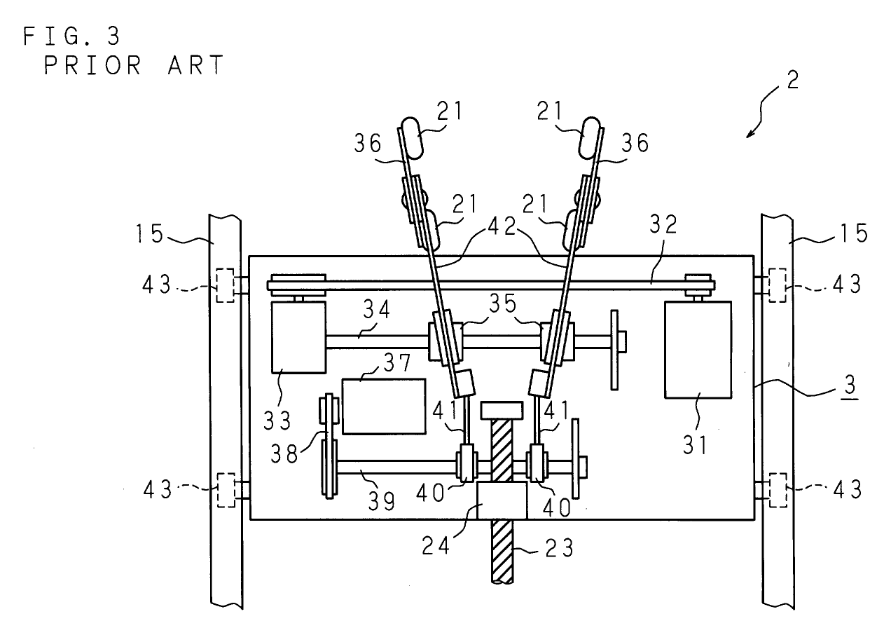

A massaging apparatus according to the first embodiment of the present invention is the same in mechanism as the conventional massaging apparatus shown in FIGS. 1 through 3, and constructed by installing a massaging mechanism 2 comprising a plurality of massaging members 21 in a chair 10. This massaging apparatus gives a massage to the human body by driving the plurality of massaging members 21 by a massaging member driving device 3 to perform a kneading operation and a tapping operation while reciprocating the massaging members 21 in upward and downward directions by a massaging member movement driving mechanism 25.

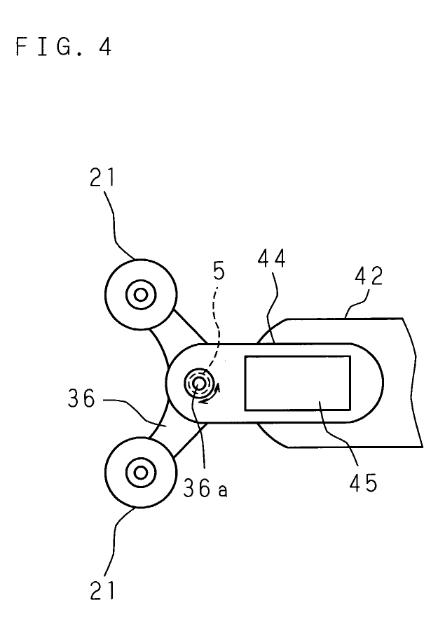

A characteristic structure of the massaging apparatus of this embodiment is that a potentiometer 5 is provided on an axis 36a of each swinging arm 36 as shown in FIG. 4. The potentiometer 5 detects a change in the swing angle of the swinging arm 36. The operations of the massaging mechanism 2 and the massaging member movement driving mechanism 25 are controlled based on this detection signal.

Besides, in the massaging apparatus of this embodiment, the swinging arm 36 is attached to one end of an auxiliary support arm 44 mounted on one end of a support arm 42. The auxiliary support arm 44 is caused to slide with respect to the support arm 42 by a slidable portion 45 provided on the other end of the auxiliary support arm 44. In this structure, it is possible to change a protruding amount of the massaging members 21 while maintaining a state in which the swinging arm 36 can freely turn with regard to the support arm 42.

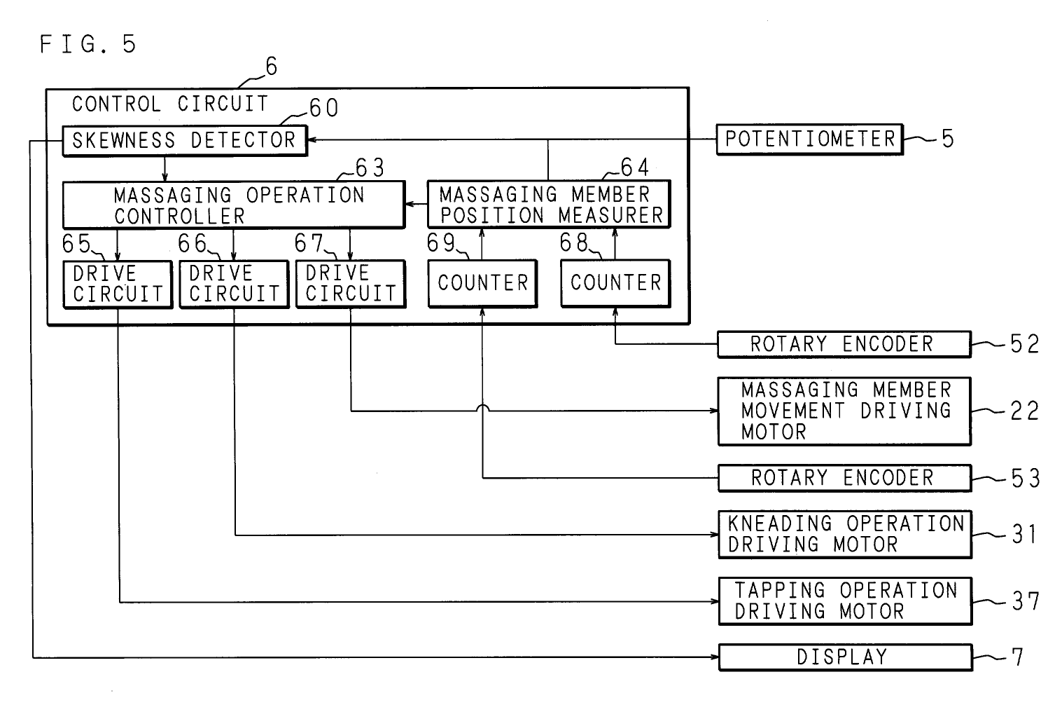

FIG. 5 is a block diagram showing the structure of a control system of the massaging apparatus of this embodiment.

The rotations of the above-mentioned massaging member movement driving motor 22, kneading operation driving motor 31 and tapping operation driving motor 37 are controlled by a control circuit 6 composed of a microcomputer. Rotary encoders 52 and 53 are mounted on the output shafts of the massaging member movement driving motor 22 and the kneading operation driving motor 31, respectively, and the detection signals of these rotary encoders 52 and 53 are supplied to the control circuit 6. The control circuit 6 comprises counters 68 and 69 for counting the rotation angle detection pulses from the rotary encoders 52 and 53, so that the rotation angles of the massaging member movement driving motor 22 and the kneading operation driving motor 31 are detected based on the count values counted by the counters 68 and 69. The detected rotation angle signals are supplied to a massaging member position measurer 64, and then the positions of the massaging members 21 are measured.

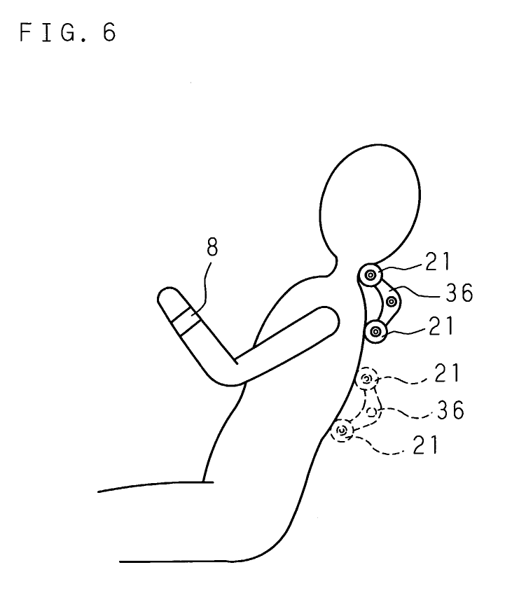

The detection signal of the potentiometer 5 is also supplied to the control circuit 6. As shown in FIG. 6, in the process of moving the massaging members 21 from the head to the back of the human body, the swinging arm 36 swings according to the curves of the human body following the track of the massaging members 21. A change in the swing angle (arm angle) is detected by the potentiometer 5, and the detection signal is supplied to the control circuit 6.

The control circuit 6 includes a skewness detector 60 which fetches the detection signal of the potentiometer 5, detects the form of the human body based on the detection signal, and then detects skewness. The skewness detector 60 comprises: a reference angle change curve storing unit for storing a reference angle change curve that indicates a change in the swing angle of the swinging arm 36 when the massaging members 21 are moved from the head to the lower back part of the human body having a reference physical attribute; a corrected angle change curve creating unit for creating a corrected angle change curve by correcting the reference angle change curve based on the user's neck and lower back positions measured by the massaging member position measurer 64; a measured angle change curve creating unit for creating a measured angle change curve that indicates a change in the swing angle of the swinging arm 36 when the massaging members 21 are moved from the head to the lower back part of the user; and a skewness detecting unit for detecting skewness of the user by comparing the created corrected angle change curve and measured angle change curve.

The skewness detection signal obtained from the skewness detector 60 and the massaging member position detection signals obtained from the massaging member position measurer 64 are supplied to a massaging operation controller 63. In accordance with these signals, the massaging operation controller 63 performs a later-described control operation, and supplies control signals to drive circuits 67, 66, 65 for driving the massaging member movement driving motor 22, kneading operation driving motor 31 and tapping operation driving motor 37, respectively.

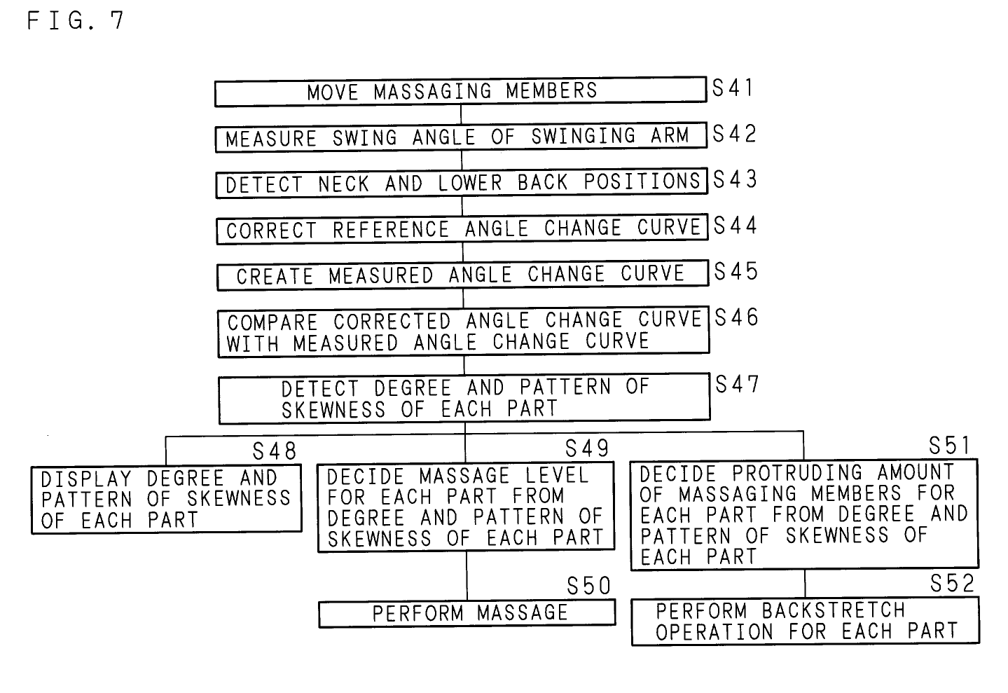

FIG. 7 is a flow chart showing the process of detecting the skewness of the user and controlling the massaging operation in the control circuit 6.

First, the massaging member movement driving motor 22 is driven to move the massaging members 21 to the initial position (the top position), and the kneading operation driving motor 31 is driven to set the width between the massaging members 21 at an initial value. Then, the massaging members 21 are moved from the head to the lower back part of the user (step S41). Next, the swing angle of the swinging arm 36 is measured with the potentiometer 5 (step S42). Then, the user's neck and lower back positions are detected. Each of these positions is detected based on a peak position obtained by performing second-order differentiation for a change in the swing angle of the swinging arm 36 and the results of detecting the massaging member positions by the massaging member position measurer 64 (step S43).

A corrected angle change curve is created by correcting a reference angle change curve pre-stored in the reference angle change curve storing unit, based on the detected positions of the neck and lower back of the user (step S44).

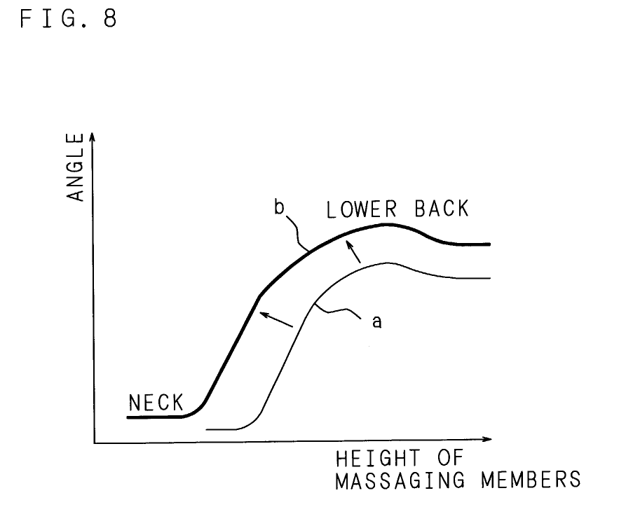

FIG. 8 is a graph showing the relationship between the swing angle of the swinging arm 36 and the height of the massaging members 21.

By correcting the reference angle change curve indicated by “a” in FIG. 8 in accordance with the detected neck and lower back positions of the user, a corrected angle change curve b corresponding to the actual neck and lower back positions of the user is obtained.

The next step is to create a measured angle change curve that indicates a change in the swing angle of the swinging arm 36 when the massaging members 21 are moved from the head to the lower back part of the user (step S45). The corrected angle change curve created in step S44 is compared with the measured angle change curve created in step S45 (step S46). Then, the degree and pattern of skewness are detected for each part (step S47).

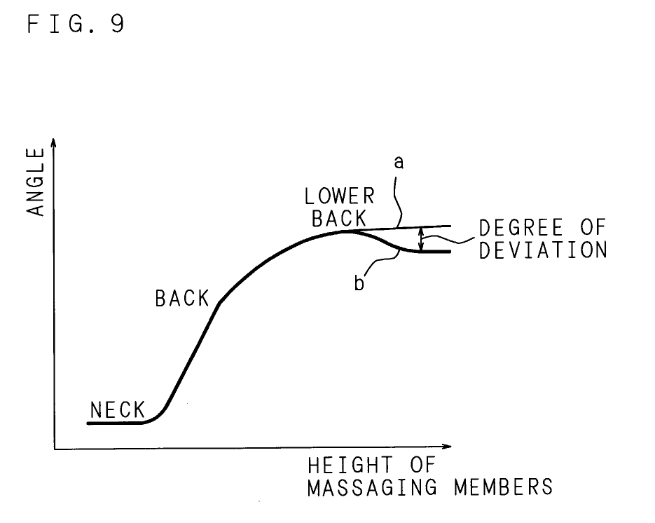

FIG. 9 is a graph showing the relationship between the swing angle of the swinging arm 36 and the height of the massaging members 21.

In FIG. 9, “b” indicates the corrected angle change curve created in step S44, and “a” represents the measured angle change curve created in step S45. It is found by comparing these two angle change curves that there is no deviation in the region from the shoulders to the back, but there is a skewness pattern representing a lower back skew that causes a deviation in the lower back part, and then the degree of deviation in the lower back part is detected.

The detected degree and pattern of skewness of each part are outputted to a display 7 so as to display the data on the display 7 (step S48). Consequently, the user can see the displayed degree and pattern of skewness of each part and utilize the data for self-management of health. Further, by transmitting the data through an electric communication channel or the like to medical professionals such as doctors, or transmitting the data together with data such as electrocardiogram, GSR, blood pressure and body fat ratio detected by a biological information measuring sensor 8 attached to a wrist of the user as shown in FIG. 6, it is possible to have a diagnosis and reflect the result on a massage.

In step S49, a massage level (such as a width to be kneaded and tapping strength) for each part is decided from the detected degree and pattern of skewness of each part. Then, a massage is performed by controlling the driving of the kneading operation driving motor 31 and the tapping operation driving motor 37, based on the decided massage level (step S50).

In step S51, a protruding amount of the massaging members 21 for each part is decided from the detected degree and pattern of skewness of each part. Then, based on the decided protruding amount, the auxiliary support arm 44 is caused to slide with respect to the support arm 42 by the slidable portion 45 shown in FIG. 4 so as to protrude the massaging members 21 and perform a backstretch operation for each part (step S52). This is carried out by controlling the driving of the massaging member movement driving motor 22 to move the massaging members 21 upward and downward.

Here, the protruding amount of the massaging members 21 at each part can be decided by any one of a method for deciding the protruding amount so that the massaging members 21 come in contact with body uniformly according to skewness of each part; and a method for deciding the protruding amount so that the massaging members 21 protrude against skewness of each part so as to correct the skewness. The user can select any one method to be used from the above two methods. Besides, an operation to be performed after protruding the massaging members 21 is not limited to the backstretch operation, and may be a tapping operation or a kneading operation.

For example, when it is judged that the lower back part has skewness, based on the change in the swing angle of the massaging members 21, and that the lower back part protrudes backward by x cm, based on the degree of deviation, as shown in FIG. 9, the protruding amount of the massaging members 21 at the lower back part is decreased by x cm from a reference value, in the former method. Accordingly, uniform stimulation (pressure) can be applied to each part despite the skewness. On the other hand, in the latter method, the protruding amount of the massaging members 21 at the lower back part is increased by y cm from a reference value to depress the backward skewness of the lower back part and thereby correct the skewness.

Regarding the above-mentioned processes in steps 48, 49 and 51, any one of or a plurality of these processes may be performed.

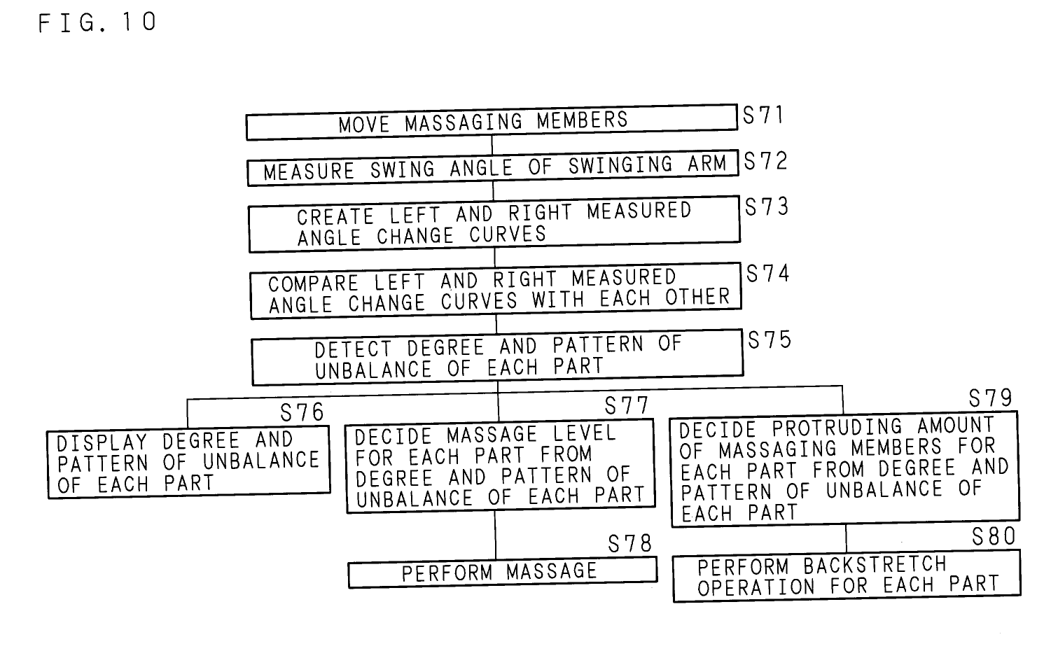

FIG. 10 is a flow chart showing the process of detecting the unbalance between the left and right sides of the body of the user and controlling the massaging operation in the control circuit 6.

First, the massaging member movement driving motor 22 is driven to move the massaging members 21 to the initial position (the top position), and the kneading operation driving motor 31 is driven to set the width between the massaging members 21 at an initial value. Then, the massaging members 21 are moved from the head to the lower back part of the user (step S71). The swing angle of the swinging arm 36 is measured with the potentiometer 5 (step S72). Based on the measured swing angle, left and right measured angle change curves of the body of the user are created (step S73).

The created left and right measured angle change curves are compared with each other (step S74). Then, the degree and pattern of unbalance of each part are detected (step S75).

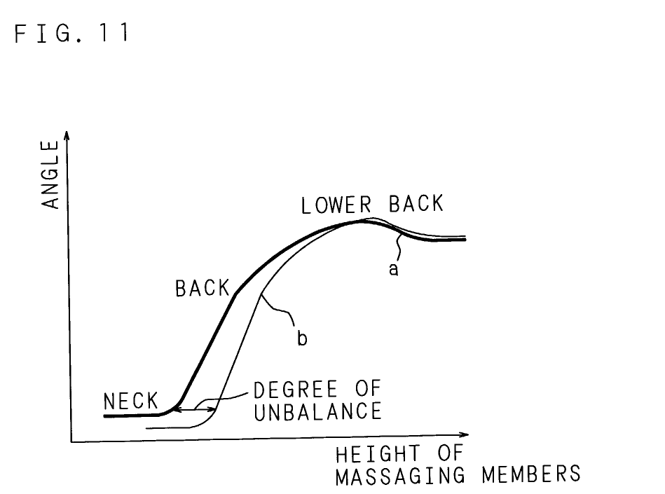

FIG. 11 is a graph showing the relationship between the swing angle of the swinging arm 36 and the height of the massaging members 21, wherein “a” represents the left measured angle change curve, and “b” indicates the right measured angle change curve.

It is found by comparing these two measured angle change curves that there is no unbalance between the left and right sides in the lower back part, but there is a shoulder/back unbalance pattern representing the unbalance caused in the shoulders and the back, and then the degree of unbalance in the neck part is detected.

The detected degree and pattern of unbalance of each part are outputted to the display 7 so as to display the data on the display 7 (step S76). Consequently, the user can see the displayed degree and pattern of unbalance of each part and utilize the data for self-management of health. Further, by transmitting the data through an electric communication channel or the like to medical professionals such as doctors, or transmitting the data together with data such as electrocardiogram, GSR, blood pressure and body fat ratio detected by the biological information measuring sensor 8 attached to a wrist of the user as shown in FIG. 6, it is possible to have a diagnosis and reflect the result on a massage.

In step S77, a massage level (such as strength of the kneading operation and tapping operation) for each part is decided from the detected degree and pattern of unbalance of each part. Then, a massage is performed by controlling the driving of the kneading operation driving motor 31 and the tapping operation driving motor 37, based on the decided massage level (step S78).

In step S79, a protruding amount of the massaging members 21 for each part is decided from the detected degree and pattern of unbalance of each part. Then, based on the decided protruding amount, the massaging members 21 are protruded by the slidable portion 45 shown in FIG. 4, and a backstretch operation is performed for each part (step S80).

Here, the protruding amount of the massaging members 21 at each part can be decided by any one of a method for deciding the protruding amount so that the massaging members 21 come in contact with body uniformly according to skewness of each part; and a method for deciding the protruding amount so that the massaging members 21 protrude against skewness of each part so as to correct the skewness. The user can select any one method to be used from the above two methods. Besides, an operation to be performed after protruding the massaging members 21 is not limited to the backstretch operation, and may be a tapping operation or a kneading operation.

For example, when it is judged that shoulders have unbalance, based on the change in the swing angle of the massaging members 21, and that the left side of the neck protrudes backward by x′ cm, based on the degree of unbalance, as shown in FIG. 11, the protruding amount of only left side massaging members 21 at the neck is decreased by x′ cm from a reference value, in the former method. Accordingly, uniform stimulation (pressure) can be applied to each part despite the skewness. On the other hand, in the latter method, the protruding amount of only left side massaging members 21 at the neck is increased by y′ cm from a reference value to depress the backward skewness of the left side of the neck and thereby correct the skewness.

Regarding the above-mentioned processes in steps 76, 77 and 79, any one of or a plurality of these processes may be performed.

As described above, with the massaging apparatus of this embodiment, the degree and pattern of skewness or the degree and pattern of unbalance of the body of the user are detected, and then the massaging operation is controlled based on the detected degree and pattern of skewness or unbalance. Hence, it is possible to obtain a high massaging effect by giving a massage, particularly on the muscles receiving high stress due to skewness, unbalance, etc., and providing a massage suitable for the physical attribute of each user, and thereby correcting the skewness and reducing stiffness.

Second Embodiment

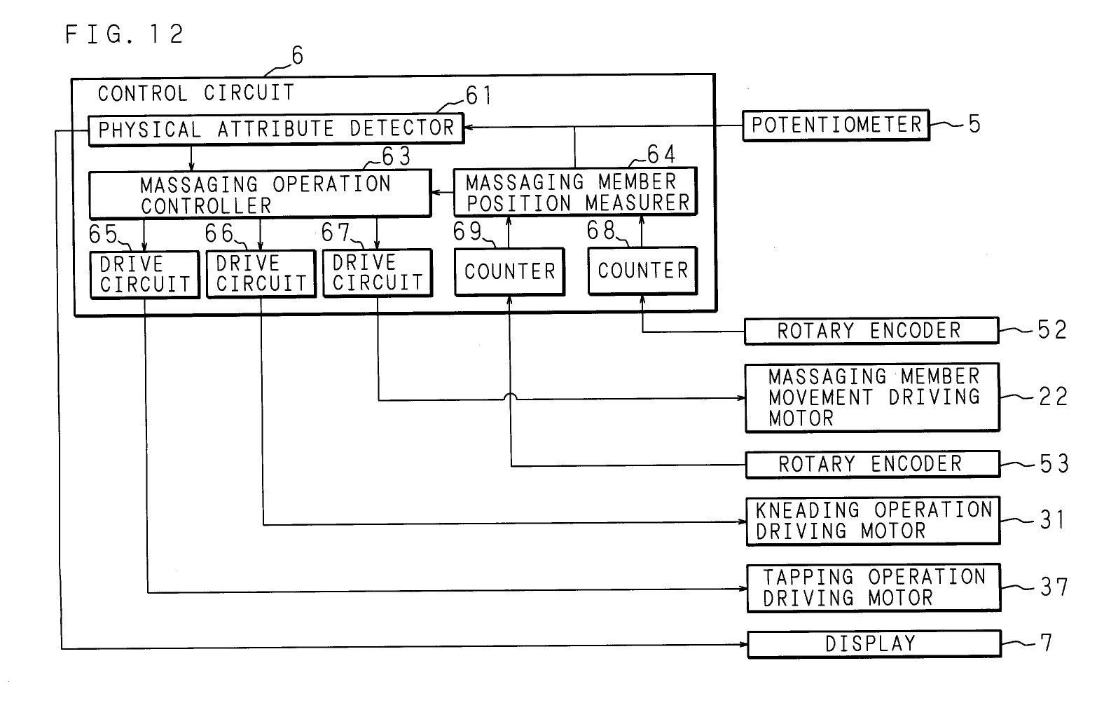

FIG. 12 is a block diagram showing the structure of a control system of a massaging apparatus according to the second embodiment.

The massaging apparatus of the second embodiment has the same structures as that of the massaging apparatus of the first embodiment, except that the control circuit 6 includes a physical attribute detector 61 in place of the skewness detector 60.

The physical attribute detector 61 comprises: a storing unit for storing a curvatures—physical attributes table that shows the relationship between the curvatures of the back and lower back part and physical attributes, and a physical attributes—massaging operations table that shows the relationship between physical attributes and massaging operations; a longitudinal curvature estimating unit for estimating the longitudinal curvatures of the back and lower back part, based on the inclination of the change in the swing angle of the swinging arm 36 detected by the potentiometer 5, for each of the back and lower pack positions of the user; a cross-directional curvature estimating unit for estimating the cross-directional curvatures of the back and lower back part, based on the inclination of the change in the swing angle detected by the potentiometer 5, for each of the above-mentioned positions; a physical attribute detecting unit for detecting the physical attribute of the user from the curvatures—physical attributes table stored in the storing unit, based on the estimated longitudinal curvatures and cross-directional curvatures; and a massaging operation deciding unit for deciding a massaging operation from the physical attributes—massaging operations table stored in the storing unit, based on the detected physical attribute of the user.

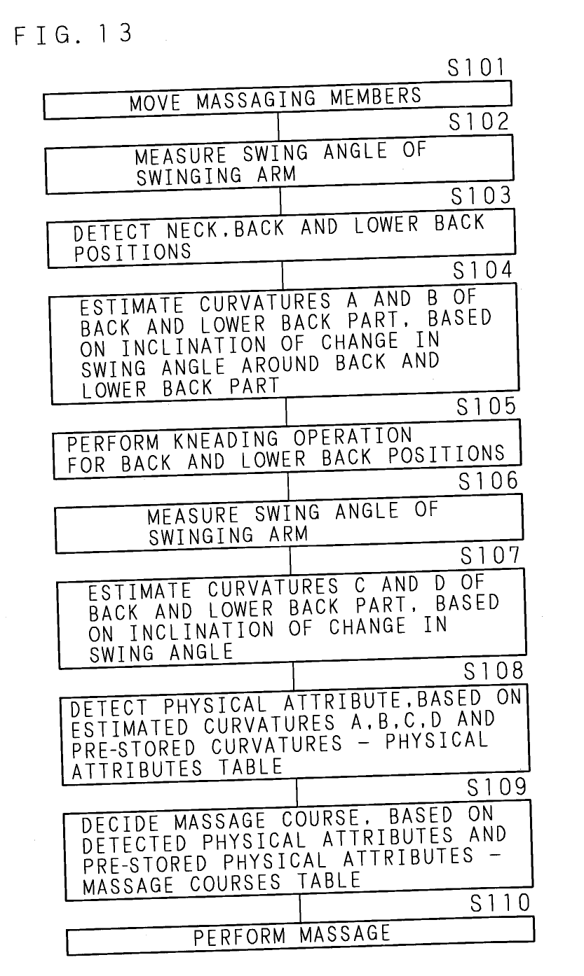

FIG. 13 is a flow chart showing the process of detecting the physical attribute of the user and controlling the massaging operation in the control circuit 6.

First, the massaging member movement driving motor 22 is driven to move the massaging members 21 to the initial position (the top position), and the kneading operation driving motor 31 is driven to set the width between the massaging members 21 at an initial value. Then, the massaging members 21 are moved from the head to the lower back part of the user (step S101). Next, the swing angle of the swinging arm 36 is measured with the potentiometer 5 (step S102). Then, the neck, back and lower back positions of the user are detected. Each position is detected based on a peak position obtained by performing second-order differentiation for a change in the swing angle of the swinging arm 36 and the results of detecting the massaging member positions by the massaging member position measurer 64 (step S103).

For the detected positions around the back and lower back part of the user, the longitudinal curvatures A and B of the back and lower back part are estimated, based on the inclination of the change in the swing angle of the swinging arm 36 when the massaging members 21 are moved in a longitudinal direction of the body (step S104). The longitudinal curvatures A and B are smaller if the user is fat, but larger if the user is skinny.

Next, for the detected back and lower back positions of the user, the kneading operation is performed by controlling the driving of the kneading operation driving motor 31 (step S105). At this time, the swing angle of the swinging arm 36 is measured (step S106).

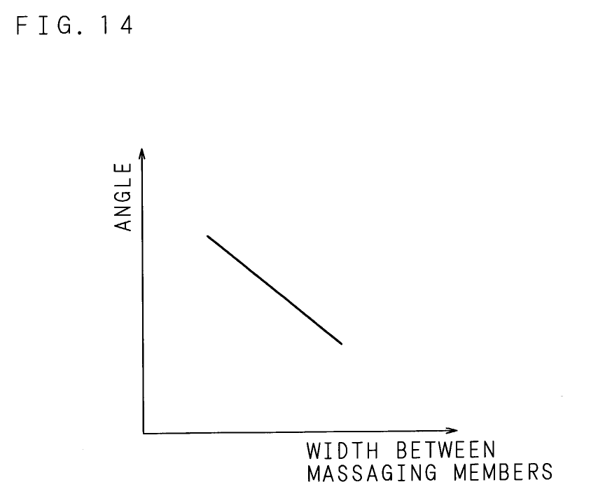

FIG. 14 is a graph showing the relationship between the swing angle of the swinging arm 36 and the width between the massaging members 21 when the kneading operation was performed on the back of the user.

Based on the inclination of the graph representing the change in the angle, a cross-directional curvature C of the back of the user is calculated. For the lower back part of the user, a cross-directional curvature D is estimated in the same manner (step S107). The cross-directional curvatures C and D are smaller if the user has a large body width, but larger if the user has a small body width.

Next, based on the estimated curvatures A, B, C and D, the physical attribute of the user is detected from the curvatures—physical attributes table pre-stored in the storing unit and showing the relationship between the curvatures and the physical attribute (step S108). Moreover, based on the detected physical attributes, a massage course is decided from the physical attributes—massage courses table pre-stored in the storing unit and showing the relationship between the physical attribute and the massage course (step S109). In accordance with the decided massage course, a massage is performed by controlling the driving of the massaging member movement driving motor 22, kneading operation driving motor 31 and tapping operation driving motor 37 (step S110).

Note that it is possible to decide massage strength (such as a width to be kneaded and tapping strength) instead of deciding a massage course in step S109. For a user who is fat and has a large body width, the strength of massage is increased.

As described above, with the massaging apparatus of this embodiment, the physical attribute of the user is detected substantially accurately by estimating the longitudinal and cross-directional curvatures of the body of the user, and then a massage course or massage strength is decided based on the detected physical attribute. Consequently, the user can automatically have a massaging operation corresponding to his/her physical attribute without making adjustments and obtain a high massaging effect to reduce stiffness.

Note that the structures of the respective parts of the present invention are not necessarily limited to those explained in the above first and second embodiments, and various design changes may be made within the technical range defined in the claims.

Besides, instead of estimating the longitudinal and cross-directional curvatures of the user at the two points of the back and lower back part as explained in the second embodiment, the longitudinal and cross-directional curvatures may be estimated at a plurality of positions so as to recognize the physical attribute of the user three-dimensionally and control the massaging operation based on the results.

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A massaging apparatus for performing a predetermined massaging operation with a massaging member attached to an end of a swinging arm, comprising a controller capable of performing operations of:
detecting skewness of a body of a user, based on a change in a swing angle of the swinging arm when performing the massaging operation on the user; and
controlling the massaging operation, based on the detected skewness.

2. A massaging apparatus comprising:
a pair of support arms;
a swinging arm supported on each top end of said support arms so that the swinging arm can freely swing;
a pair of massaging members mounted on both ends of each swinging arm;
a kneading operation driving unit for performing a kneading operation by opening and closing said two support arms along a first direction;
a reciprocation driving unit for reciprocating the support arms in a longitudinal direction;
a tapping operation driving unit for performing a tapping operation by swinging the support arms along a second direction crossing the first direction; and
a swing angle detecting unit for detecting a change in a swing angle of each swinging arm in a process of reciprocating the support arms,
wherein the controller is capable of performing further operations of:
detecting a body form of the user, based on the detected change in the swing angle;
detecting skewness of the body of the user, based on the detected body form of the user; and
controlling driving of the kneading operation driving unit, reciprocation driving unit and tapping operation driving unit, based on the detected skewness.

3. The massaging apparatus according to claim 2, wherein the controller is capable of performing further operations of:
storing a reference angle change curve that indicates a change in the swing angle based on a reference physical attribute;
detecting positions of a plurality of parts of the body of the user, based on the detected change in the swing angle;
creating a corrected angle change curve by correcting the stored reference angle change curve, based on the detected positions;
creating a measured angle change curve, which indicates an actual angle change curve corresponding to the user, based on the detected change in the swing angle;
detecting skewness of the user by comparing the created corrected angle change curve with the created measured angle change curve; and
controlling driving of the kneading operation driving unit, reciprocation driving unit and tapping operation driving unit, based on the detected skewness.

4. The massaging apparatus according to claim 3, wherein the controller is capable of outputting the detected skewness to an external device.

5. The massaging apparatus according to claim 2, wherein the controller is capable of performing further operations of:
creating measured angle change curves, which indicate actual angle change curves corresponding to the user, based on changes in the swing angles of the swinging arms at the left and right sides of the body, respectively;
detecting left and right skewness of the user by comparing the created left and right measured angle change curves; and
controlling driving of the kneading operation driving unit, reciprocation driving unit and tapping operation driving unit, based on the detected skewness.

6. The massaging apparatus according to claim 5, wherein the controller is capable of outputting the detected skewness to an external device.

7. The massaging apparatus according to claim 2, wherein the controller is capable of performing further operations of:
detecting a change in the swing angle of each swinging arm in a process of performing the kneading operation by opening and closing the support arms along the first direction;
detecting a body form in a cross direction of the user, based on the detected change in the swing angle; and
controlling driving of the kneading operation driving unit, reciprocation driving unit and tapping operation driving unit, based on the detected body form in a cross direction of the user.

8. The massaging apparatus according to claim 7, wherein the controller is capable of performing further operations of:
storing a curvatures—physical attributes table that indicates a relationship between curvatures of the back and lower back part and physical attributes;
storing a physical attributes—massaging operations table that indicates a relationship between physical attributes and massaging operations;
estimating longitudinal curvatures of the back and lower back part, based on an inclination of the detected change in the swing angle in the process of reciprocating the support arms, for each of the detected positions of the back and lower back part of the user;
estimating cross-directional curvatures of the back and lower back part, based on an inclination of the detected change in the swing angle in the process of performing the kneading operation by opening and closing the support arms along the first direction, for each of said positions;
detecting a physical attribute of the user from the stored curvatures—physical attributes table, based on the estimated longitudinal curvatures and cross-directional curvatures;
deciding a massaging operation from the stored physical attributes—massaging operations table, based on the detected physical attribute of the user; and
controlling driving of the kneading operation driving unit, reciprocation driving unit and tapping operation driving unit, based on the decided massaging operation.

9. The massaging apparatus according to claim 7, wherein the controller is capable of outputting the detected skewness to an external device.

10. The massaging apparatus according to claim 2, wherein the controller is capable of outputting the detected skewness to an external device.

11. A massaging apparatus for performing a predetermined massaging operation with a massaging member attached to an end of a swinging arm, comprising:
detecting means for detecting skewness of a body of a user, based on a change in a swing angle of the swinging arm when performing the massaging operation on the user; and
control means for controlling the massaging operation, based on the detected skewness.

12. A massaging apparatus comprising:
a pair of support arms;
a swinging arm supported on each top end of said support arms so that said swinging arm can freely swing;
a pair of massaging members mounted on both ends of each swinging arm;
kneading operation driving means for performing a kneading operation by opening and closing said two support arms along a first direction;
reciprocation driving means for reciprocating the support arms in a longitudinal direction;
tapping operation driving means for performing a tapping operation by swinging the support arms along a second direction crossing the first direction;
swing angle detecting means for detecting a change in a swing angle of each swinging arm in a process of reciprocating the support arms,
form detecting means for detecting a body form of the user, based on the change in the swing angle detected by said swing angle detecting means;
skewness detecting means for detecting skewness of the body of the user, based on the body form of the user detected by said form detecting means; and
drive-control means for controlling driving of the kneading operation driving means, reciprocation driving means and tapping operation driving means, based on the skewness detected by said skewness detecting means.

13. The massaging apparatus according to claim 12, further comprising:
reference angle change curve storing means for storing a reference angle change curve that indicates a change in the swing angle based on a reference physical attribute;
position detecting means for detecting positions of a plurality of parts of the body of the user, based on the change in the swing angle detected by the swing angle detecting means;
corrected angle change curve creating means for creating a corrected angle change curve by correcting the reference angle change curve stored in the reference angle change curve storing means, based on the positions detected by the position detecting means; and
measured angle change curve creating means for creating a measured angle change curve, which indicates an actual angle change curve corresponding to the user, based on the change in the swing angle detected by the swing angle detecting means,
wherein the skewness detecting means detects skewness of the user by comparing the corrected angle change curve created by the corrected angle change curve creating means with the measured angle change curve created by the measured angle change curve creating means, and
the drive-control means controls driving of the kneading operation driving means, reciprocation driving means and tapping operation driving means, based on the skewness detected by the skewness detecting means.

14. The massaging apparatus according to claim 13, further comprising means for outputting the skewness detected by the skewness detecting means to an external device.

15. The massaging apparatus according to claim 12, further comprising:
left and right measured angle change curve creating means for creating measured angle change curves, which indicate actual angle change curves corresponding to the user, based on changes in the swing angles of the swinging arms at the left and right sides of the body, respectively; and
left and right skewness detecting means for detecting left and right skewness of the user by comparing the left and right measured angle change curves created by said left and right measured angle change curve creating means with each other,
wherein the drive-control means controls driving of the kneading operation driving means, reciprocation driving means and tapping operation driving means, based on the skewness detected by said left and right skewness detecting means.

16. The massaging apparatus according to claim 15, further comprising means for outputting the skewness detected by the skewness detecting means to an external device.

17. The massaging apparatus according to claim 12, further comprising:
swing angle detecting means for detecting a change in the swing angle of each swinging arm in a process of performing the kneading operation by opening and closing the support arms along the first direction; and
cross-directional form detecting means for detecting a body form in a cross direction of the user, based on the change in the swing angle detected by said swing angle detecting means,
wherein the drive-control means controls driving of the kneading operation driving means, reciprocation driving means and tapping operation driving means, based on the body form in a cross direction of the user detected by said cross-directional form detecting means.

18. The massaging apparatus according to claim 17, further comprising:
storing means for storing a curvatures—physical attributes table that indicates a relationship between curvatures of the back and lower back part and physical attributes, and a physical attributes—massaging operations table that indicates a relationship between physical attributes and massaging operations;
longitudinal curvature estimating means for estimating longitudinal curvatures of the back and lower back part, based on an inclination of the change in the swing angle detected by the swing angle detecting means in the process of reciprocating the support arms, for each of the positions of the back and lower back part of the user detected by the position detecting means;
cross-directional curvature estimating means for estimating cross-directional curvatures of the back and lower back part, based on an inclination of the change in the swing angle detected by the swing angle detecting means in the process of performing the kneading operation by opening and closing the support arms along the first direction, for each of said positions;
physical attribute detecting means for detecting a physical attribute of the user from the curvatures—physical attributes table stored in the storing means, based on the longitudinal curvatures and cross-directional curvatures estimated by the longitudinal curvature estimating means and cross-directional curvature estimating means; and
massaging operation deciding means for deciding a massaging operation from the physical attributes—massaging operations table stored in the storing means, based on the physical attribute of the user detected by the physical attribute detecting means,
wherein the drive-control means controls driving of the kneading operation driving means, reciprocation driving means and tapping operation driving means, based on the massaging operation decided by said massaging operation deciding means.

19. The massaging apparatus according to claim 17, further comprising means for outputting the skewness detected by the skewness detecting means to an external device.

20. The massaging apparatus according to claim 12, further comprising means for outputting the skewness detected by the skewness detecting means to an external device.
